(19) United States
(12) Patent Application Publication
(10) Pub. No.: US 2012/0212494 A1
(43) Pub. Date: Aug. 23, 2012

(54) TYPEFACE HAVING INTERCHANGEABLE INDICIA

(76) Inventors: MELINDA BOYLE, Seattle, WA (US); Howard Boyle, Seattle, WA (US)

(21) Appl. No.: 13/032,527

(22) Filed: Feb. 22, 2011

(51) Int. Cl. G06T 11/60

(52) U.S. Cl. 345/471

(57) ABSTRACT

A typeface having interchangeable indicia.

### TECHNICAL FIELD

The invention described herein relates to typeface and more specifically, typeface font having interchangeable indicia.

### BACKGROUND OF INVENTION

Typeface is typically defined as a set of fonts having stylistic unity, each comprising a coordinated set of parameters such as size, boldness, and obliqueness. A typeface usually comprises an alphabet, numerals, and punctuation marks, or some combination thereof. Typefaces are usually divided into two categories: (1) typeface that can be used for the body of text; and (2) ornamental typeface. Ornamental typefaces are exclusively for decorative purposes and are not suitable for body text. These typefaces may incorporate pictures of objects or animals, for example. A typeface does not exist that can be used for the body of text but is also ornamental nature. Further, a typeface does not exist that allows the user of the typeface to determine the objects, or indicia, represented by the typeface.

### BRIEF DESCRIPTION OF INVENTION

An object of the typeface described herein is to provide readable fonts that are also ornamental. A second object of the typeface is to allow a user to personalize fonts for a particular occasion or theme. Another object of the typeface is to allow the user to create a unique, amalgamated variation of fonts.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1A is a face view of a first embodiment of the typeface, representing capital letters “A” through “Z”, having interchangeable indicia;

FIG. 1B is a face view of a first embodiment of the typeface, representing numerals “0” through “9”, having interchangeable indicia;

FIG. 1C is a face view of a first embodiment of the typeface, representing characters “!”, “$”, “%”, “&”, and “?”, having interchangeable indicia;

FIG. 1D is a face view showing exemplary indicia being placed into the first embodiment of a typeface having interchangeable indicia;

FIG. 2A is a face view of a second embodiment of the typeface, representing capital letters “A” through “Z”, having interchangeable indicia;

FIG. 2B is a face view of a second embodiment of the typeface, representing numerals “0” through “9”, having interchangeable indicia;

FIG. 2C is a face view of a second embodiment of the typeface, representing characters “!”, “$”, “%”, “&”, and “?”, having interchangeable indicia;

FIG. 2D is a face view showing exemplary indicia being placed into the second embodiment of a font having interchangeable indicia.

FIG. 3A is a face view of a third embodiment of the typeface, representing capital letters “A” through “Z”, having interchangeable indicia;

FIG. 3B is a face view of a third embodiment of the typeface, representing numerals “0” through “9”, having interchangeable indicia;

FIG. 3C is a face view of a third embodiment of the typeface, representing characters “!”, “$”, “%”, “&”, and “?”, having interchangeable indicia;

FIG. 3D is a face view showing exemplary indicia being placed into the third embodiment of a font having interchangeable indicia.

### DETAILED DESCRIPTION OF THE INVENTION

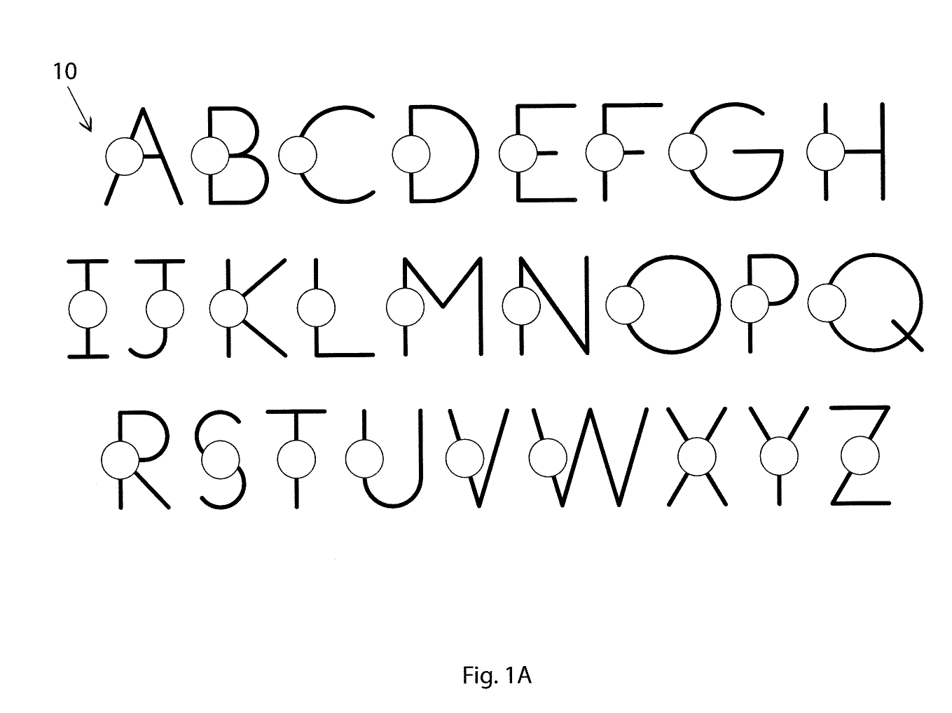

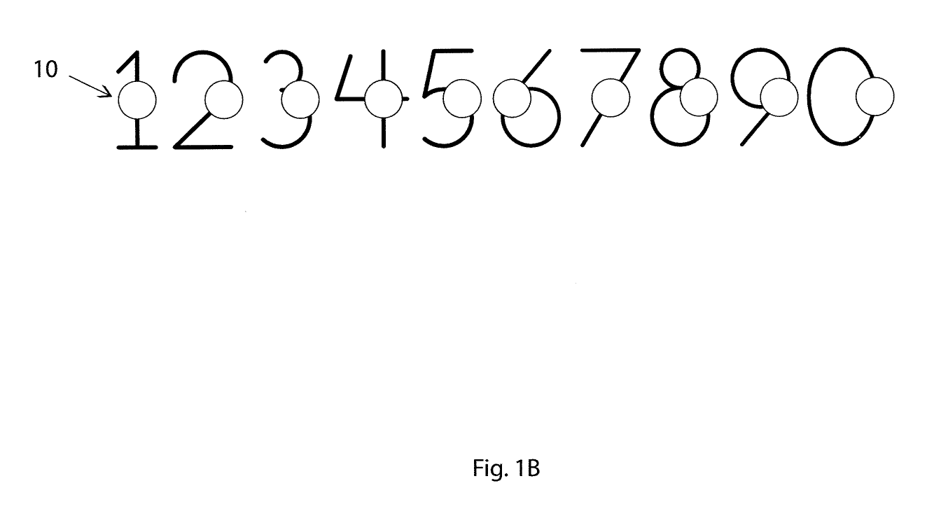

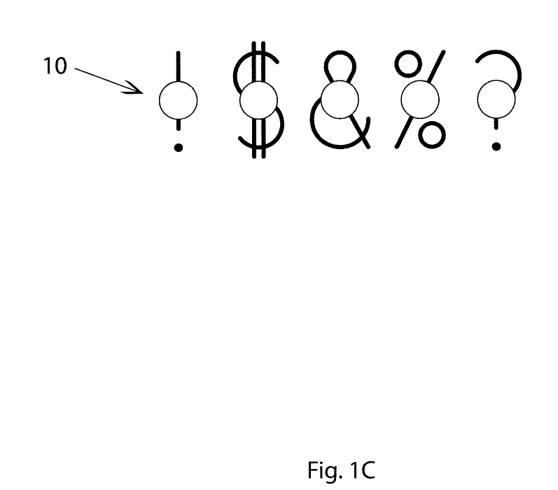

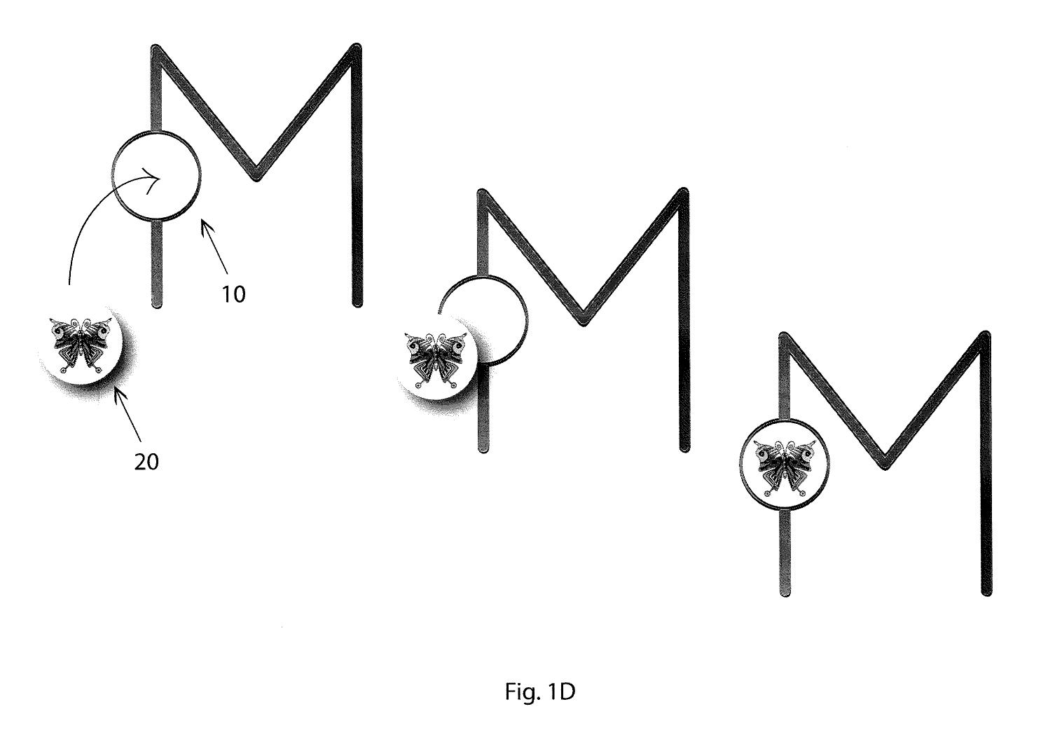

In the description of the invention above and in the detailed description of the invention and claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally. FIGS. 1A-1C, 2A-2C, and 3A-3C show exemplary drawings of the typeface claimed herein.

In one preferred embodiment, FIGS. 1A-1C, the typeface comprises a compound mask drop-out (“drop-out”) (10) that accepts indicia chosen by a user. FIG. 1D shows indicia (20) being moved into a drop-out (10). The drop-out (10) shows the indicia (20) being placed behind it and acts as a frame for the indicia (20).

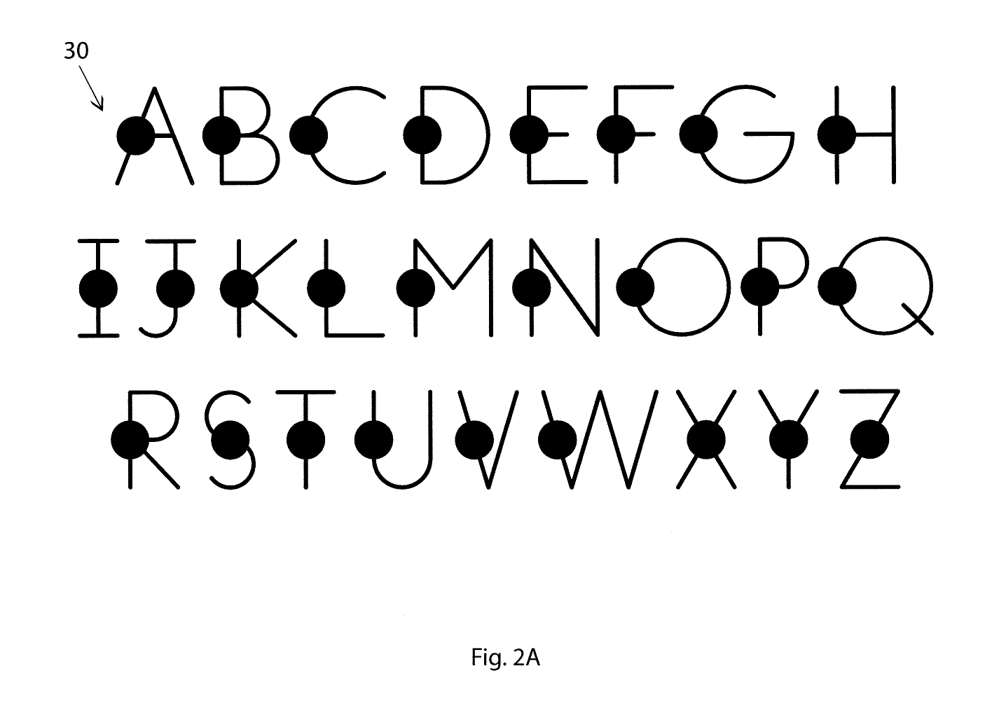

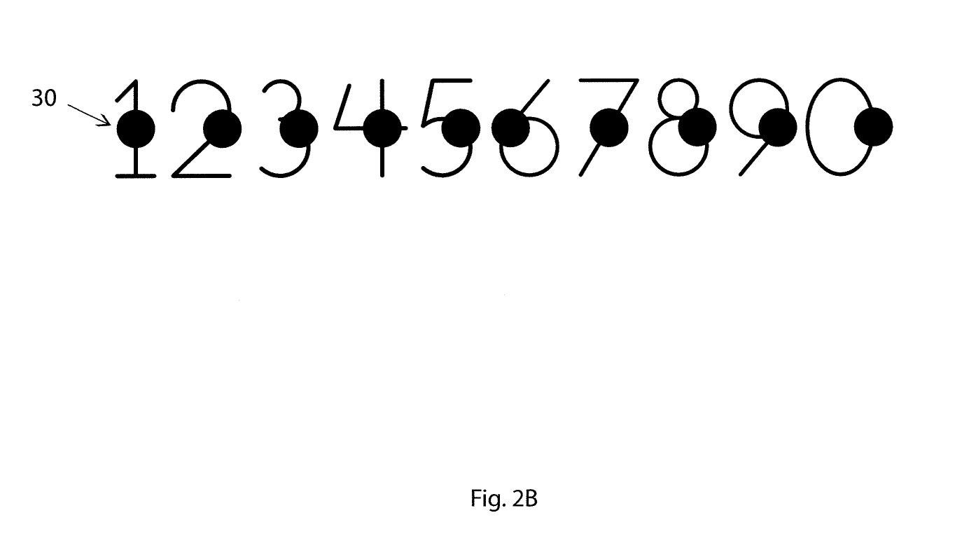

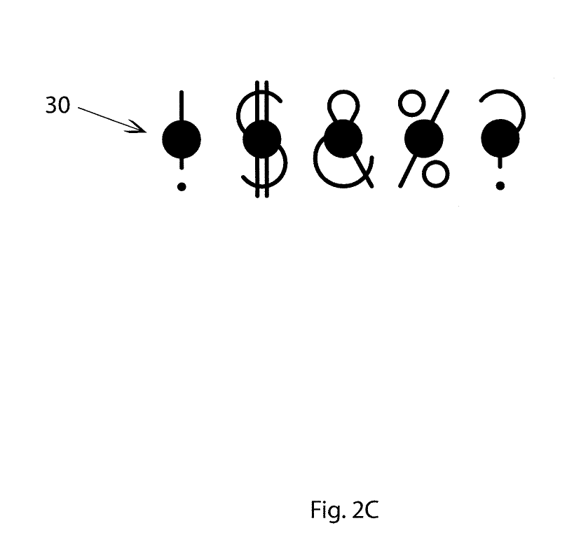

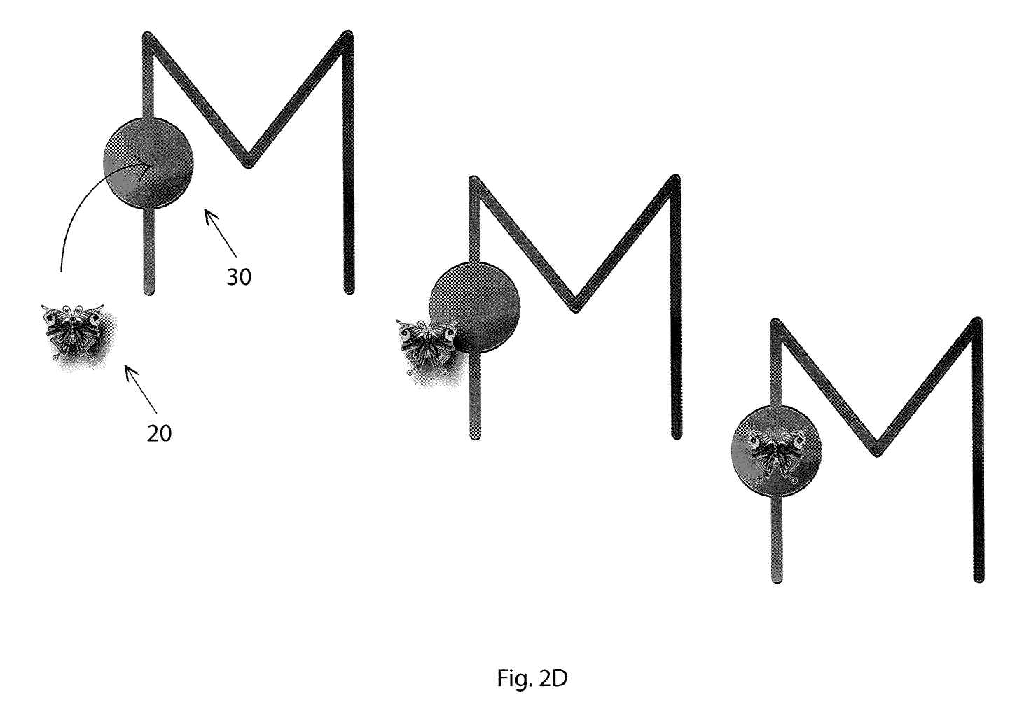

In another preferred embodiment, FIGS. 2A-2C, the typeface comprises a frame (30) that accepts indicia (20) chosen by the user. FIG. 2D shows indicia (20) being moved into a frame. Although drop-outs (10) and frames (30) are shown as circles, it will be obvious to a person having ordinary skill in the art that the drop-outs (10) and frames (30) can be of any geometric or other shapes (e.g. cars, animals, buildings, amongst others).

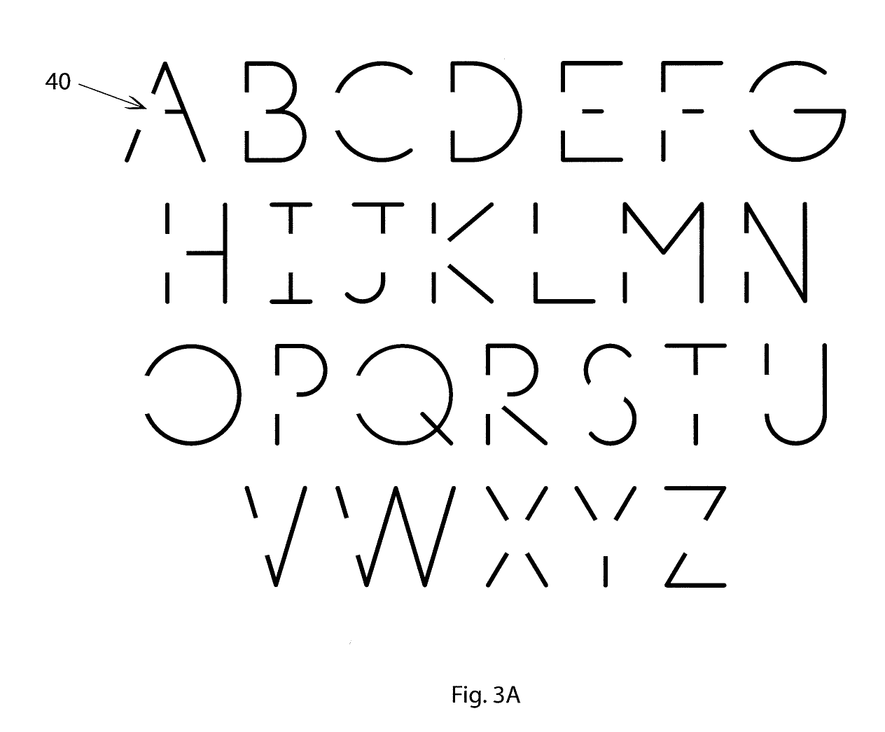

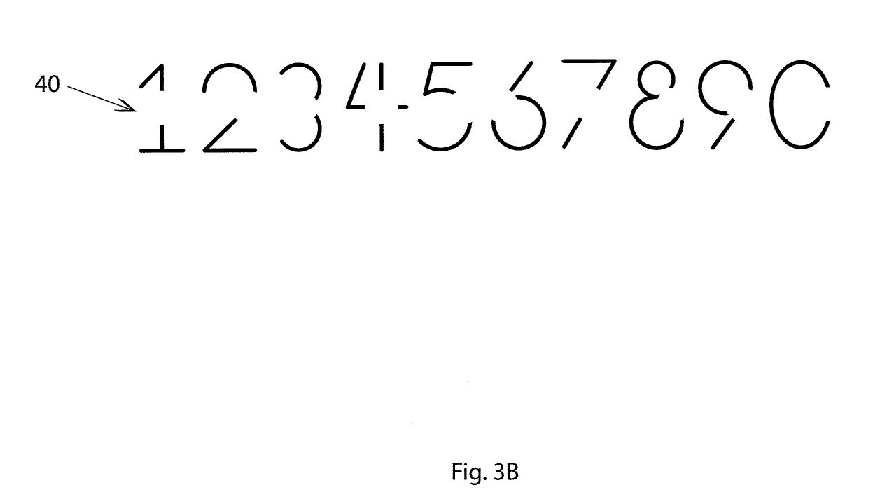

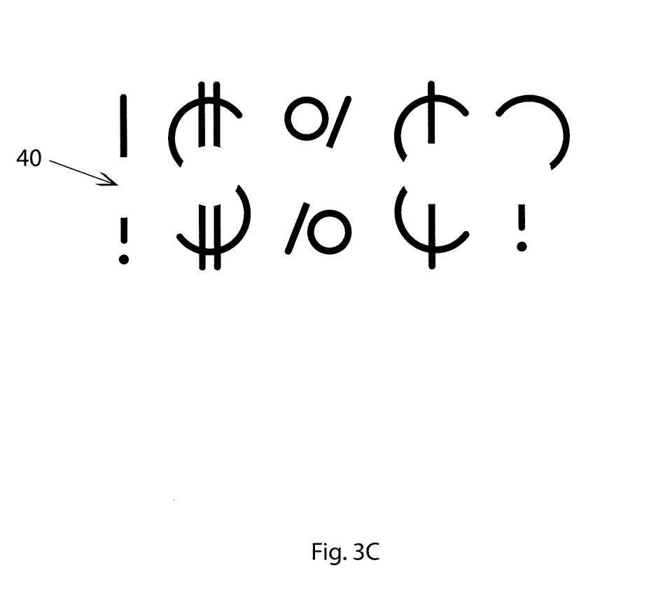

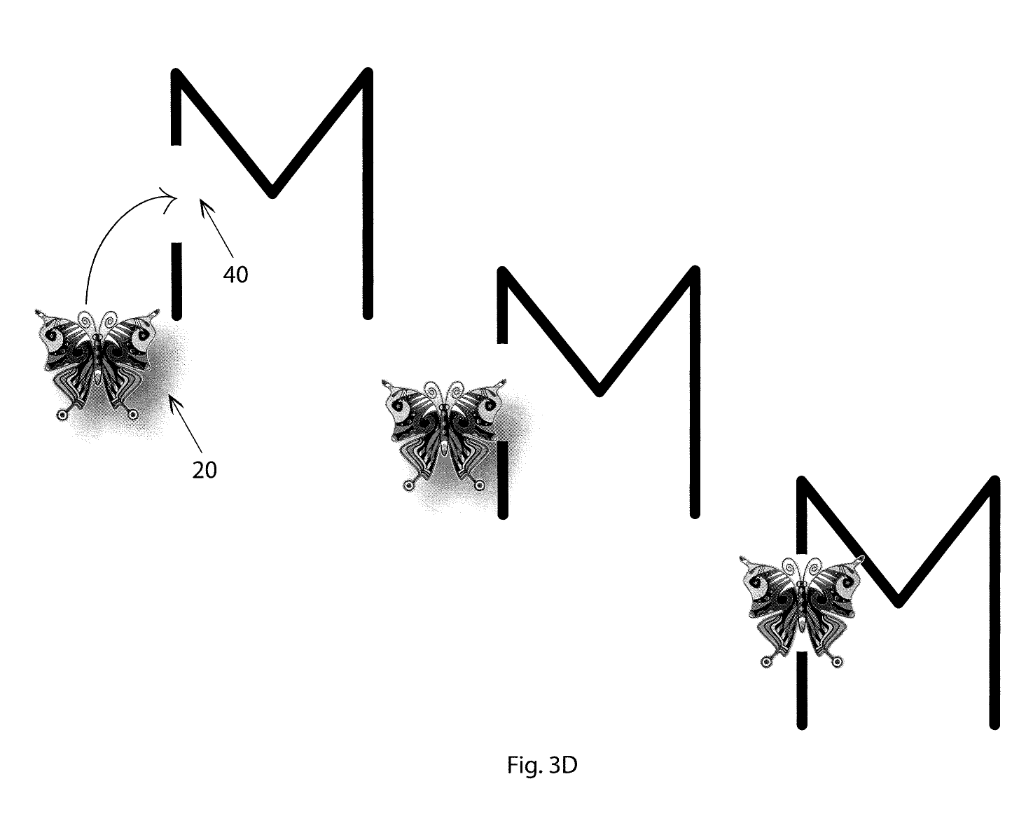

In a third preferred embodiment, FIGS. 3A-3C, the typeface defines empty space (40) that accepts indicia (20) chosen by a user. FIG. 3D shows indicia (20) being moved into an empty space (40).

The typeface with indicia inserted can be presented as one piece or as multiple pieces. The indicia are aligned to the center line of each font. Additionally, although in each of the preferred embodiments, discussed above, a butterfly is shown for exemplary purposes, it will be obvious to a person having ordinary skill in the art that the indicia can be any image. In a preferred embodiment, users will be able to purchase interchangeable indicia to place into the typeface.

A user can amalgamate the typeface to create unique indicia. Referring to Table 1, for exemplary purposes, a user chooses, at least, two fonts and reverses the fonts, as necessary to align the drop-outs (10), frames (30), or empty space (40) align to the center, as shown on Table 1, steps 1-2. The at least two fonts are overlapped so that the drop-outs (10), frames (30), or empty space (40) overlap, as shown on Table 1, step 3. That amalgamated font can then be rotated several times until desired indicia (20) is obtained, as shown in Table 1, steps 4-6. That desired indicia (20) can then be placed into a font of the typeface described herein, as shown in Table 1, step 7.

What is claimed is:

1. A typeface comprising at least one locale that accepts interchangeable indicia.

2. The typeface of claim 1 where the at least one locale is a compound mask drop-out.

3. The typeface of claim 2 where indicia is placed behind the compound mask drop-out and said compound mask drop-out frames indicia.

4. The typeface of claim 1 where the at least one locale is a frame.

5. The typeface of claim 4 where indicia is placed inside the frame.

6. The typeface of claim 1 where the at least one locale is defined as an empty space.

7. The typeface of claim 6 where indicia is placed into the empty space.

8. The typeface of claim 1 with inserted indicia is one piece.

9. The typeface of claim 1 with inserted indicia is two pieces.

10. The typeface of claim 1 where indicia are aligned to each font's centerline.

11. A method to amalgamate the typeface of claim 1 to create indicia comprising:
a. choosing at least two fonts;
b. overlap fonts so that drop-outs, frames, or empty space overlaps.
